(19) United States
(12) Patent Application Publication
(10) Pub. No.: US 2002/0093155 A1
(43) Pub. Date: Jul. 18, 2002

(54) Shopping cart self actuation brake with cart nesting brake release

(76) Inventor: Raymond M. Scott, Gonzales, LA (US)

Correspondence Address: Law Offices of John D. Gugliotta, P.E., Esq., 202 Delaware Building, 137 South Main Street, Akron, OH, 44308, US

(21) Appl. No.: 09/764,743

(22) Filed: Jan. 18, 2001

(51) Int. Cl. B62D 39/00

(52) U.S. Cl. 280/33.994

(57) ABSTRACT

A braking system is provided for a wire frame shopping cart having an actuation handle that communicates a braking force via a cable to the rear wheels such that an unobstructed nesting access area is maintained. In this manner, such carts can be “nested” in a conventional fashion. Further, when “nested”, the braking mechanism is released upon nesting.

### RELATED APPLICATIONS

The present invention was first described in Disclosure Document No. 479,632 filed on Sep. 11, 2000. There are no previously filed, nor currently any co-pending applications, anywhere in the world.

### BACKGROUND OF THE INVENTION

1. Field of the Invention

The present invention relates generally to grocery type shopping carts and, more particularly, to a wire frame grocery shopping cart brake mechanism that allows for automatic braking, yet releases upon nesting.

2. Description of the Related Art

Just about all of us have experienced the unfortunate incident of leaving a store and seeing a shopping cart smashed up against our car. While this event is usually accidental and caused by high winds or inclined parking surfaces, it does nothing to ease our aggravation. While many stores have recently begun using cart corals to store used carts in the parking lots, they do little good if inconsiderate people do not place their carts in them after use. Additionally, many parking lots are on inclined surfaces and it is almost impossible to unload a cart without having it try to scoot away while placing items in the car. If only one person is performing the unloading operation, he or she is forced to hold the cart with one foot while unloading it, which requires the skills of an acrobat to accomplish.

Another problem occurs from the method in which shopping carts are gathered and returned for shopper use. Generally, the carts are nested in linear alignment and then returned as one large train. However, a self actuating braking system would result in such a train having a number of brakes being applied, making quick return impossible.

A search of the prior art did not disclose any patents that read directly on the claims of the instant invention; however, the following references were considered related:

The following patents disclose the design and function of a shopping cart

with brake assembly.

U.S. Pat. No. 6,098,999 issued in the name of Anastasia et al.

U.S. Pat. No. 5,566,788 issued in the name of Smith et al.

U.S. Pat. No. 5,390,942 issued in the name of Schuster et al.

U.S. Pat. No. 5,042,622 issued in the name of Smith et al.

U.S. Pat. No. 4,976,447 issued in the name of Batson

U.S. Pat. No. 4,840,388 issued in the name of Doughty

U.S. Pat. No. 3,356,185 issued in the name of Issacks

U.S. Pat. No. 3,117,653 issued in the name of Altherr

U.S. Pat. No. D 362,529 issued in the name of Hilaire, Jr. et al.

U.S. Pat. No. D 338,307 issued in the name of Shaffer et al.

The following patents describe a hand operated shopping cart brake assembly.

U.S. Pat. No. 5,735,367 issued in the name of Brubaker

U.S. Pat. No. 5,199,534 issued in the name of Goff

U.S. Pat. No. 5,090,517 issued in the name of Doughty

Consequently, there exists a need for a means by which shopping carts can be utilized without the disadvantages and drawbacks as described above, namely providing a pulley guided locking system specifically adapted to prevent interference when nesting the grocery carts for storage.

### SUMMARY OF THE INVENTION

It is therefore an object of the present invention to provide an improved shopping cart brake mechanism.

It is a feature of the present invention to provide an improved shopping cart brake mechanism that allows for automatic braking, yet releases upon nesting.

Briefly described according to one embodiment of the present invention, an apparatus is provided that prevents a shopping cart from being moved without first disengaging a handle mounted braking system. Upon initial observation of a shopping cart equipped with the invention, nothing is noticeable. However, after closer inspection, a small brake release handle can be seen running across the entire bottom of the shopping cart handle. The brake handle is connected to brake pads on the rear wheels of the shopping cart via brake cables and a series of springs. The system works in a similar manner to that of a brake system on a bicycle, but in an opposite manner. To move an invention-equipped cart, the user must first squeeze the brake handle to release the brake system and then push the cart.

When the user releases the handle or otherwise steps away from the cart, the invention will automatically lock the rear wheels, via spring pressure, thus prohibiting it from moving.

The use of the present invention provides a method to prevent shopping carts from being inadvertently moved when not being pushed in a manner which is quick, easy and efficient.

In accordance with a preferred embodiment,

other advantages of the present invention include prevention of shopping cart from moving when no one is present, thereby preventing damage to automobiles in parking lots.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of a shopping cart having a self actuating braking system according to the preferred embodiment of the present invention;

FIG. 2 is a side elevational view thereof;

FIG. 3 is a rear elevational view;

FIG. 4a is a detailed side elevational view of a rear wheel spring brake for use with the present invention;

FIG. 4b is a front elevational view of the rear wheel spring brake of FIG. 4a;

FIG. 5 is a detailed elevational view of a brake release actuator handle for use with the present invention; and

FIG. 6 is a side elevational diagram depicting automatic brake release upon nesting of a first grocery shopping cart within a second grocery shopping cart, each utilizing the present invention.

### DESCRIPTION OF THE PREFERRED EMBODIMENTS

The best mode for carrying out the invention is presented in terms of its preferred embodiment, herein depicted within the Figures.

1. Detailed Description of the Figures

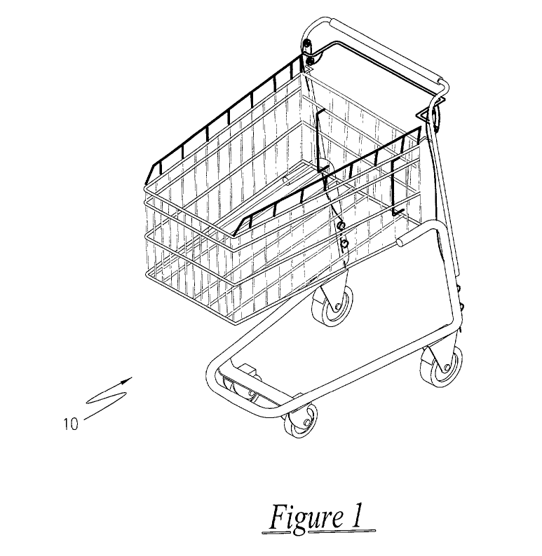

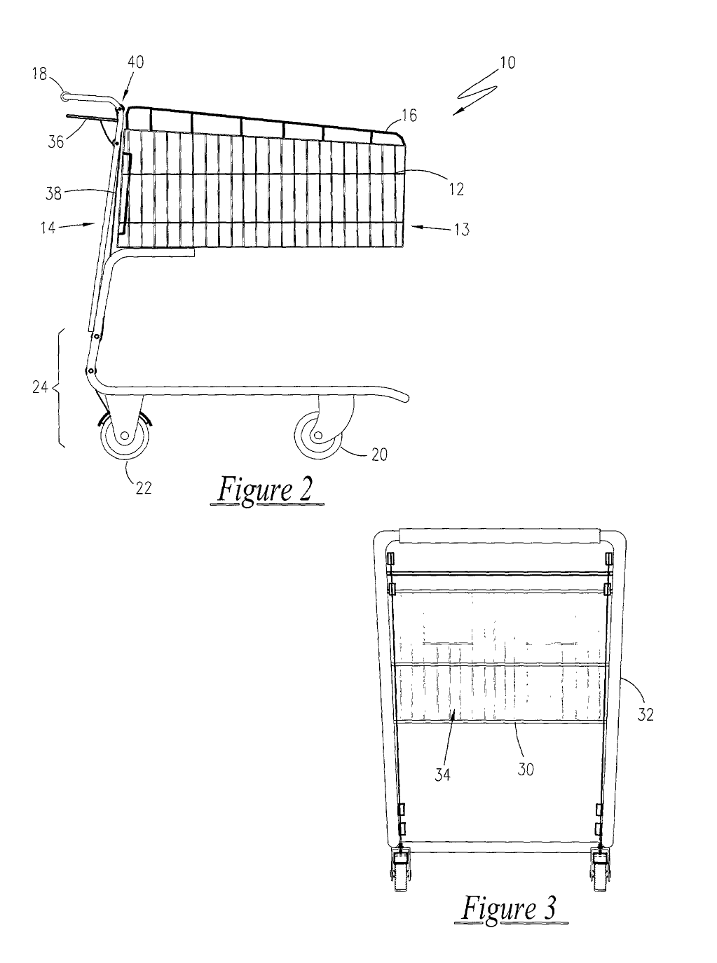

Referring now to FIG. 1-3, a shopping cart 10 is shown, according to the present invention, anticipated as being an otherwise conventional, wire frame shopping cart having a basket 12 having a front 13 opposite a rear 14 and forming an upper opening circumscribed by an upper peripheral rim 16. Although a wire frame cart is shown for purposes of disclosing the best mode of the present invention, it would be apparent to one skilled in the art in conjunction with the present disclosure to adapt the present invention for use with plastic, molded type shopping carts, as well as any other type of commercially available nesting shopping cart.

As with an otherwise conventional cart 12, a handle 18 is supported at the rear, and the cart is rolled and supported on a pair of laterally rotatable, front castor wheels 20 opposite a pair of non-pivoting rear wheels 22. A spring urged brake mechanism 24, as will be described in greater detail below, selectively impinge against the rear wheels 22 in order to provide a braking force. Along the rear periphery of the basket 12 is a basket rear frame 30 having a pair of basket side frames 32 and forming an unobstructed nesting access area 34. As shown in conjunction with FIG. 3, and described in greater detail below in conjunction with FIG. 6, the presence and availability of this unobstructed nesting access area 34 provides some key functional for the practical application and commercial viability for use of a shopping cart braking mechanism.

Finally, an actuation lever 36, mounted in an articulated manner near or to the handle 18 is in mechanical communication with the spring urged brake mechanism 24 by an actuation cable 38. An actuation guide means 40, shown herein as a series of pulleys, allows the mechanical communication of a brake release force from a location remove from the spring urged brake mechanism 24, namely from near the handle 18, in a manner that avoids obstruction of or access to the nesting access area 34.

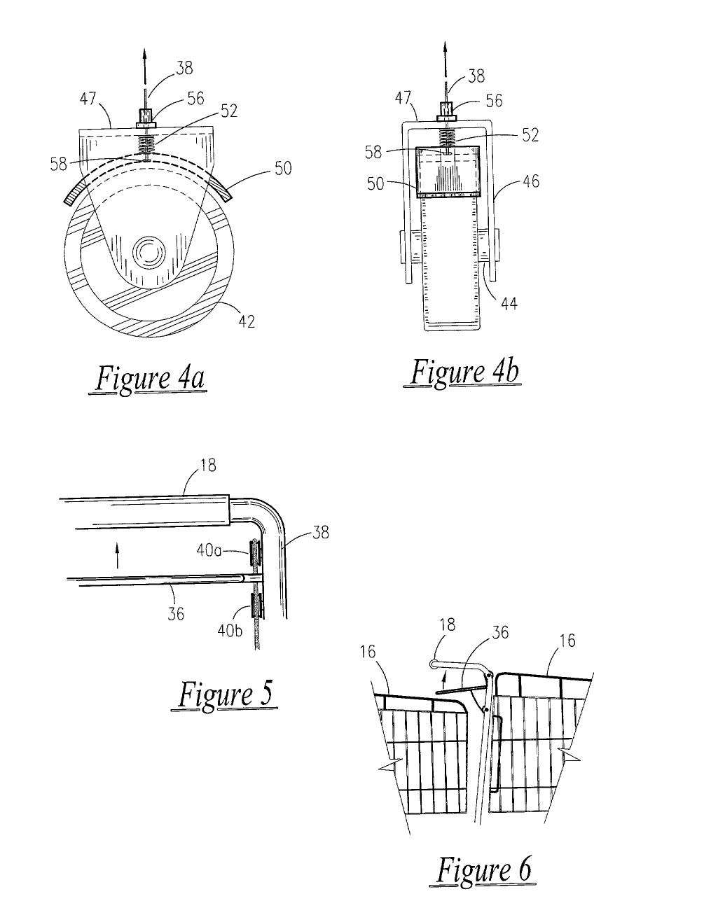

Referring to FIG. 4a and 4b, the spring urged brake mechanism 24 is shown in greater detail. Although the art is replete with examples of wheel braking mechanisms, many of which can be adapted for use within the teachings of the present disclosure, for purposes of disclosing a best mode the spring urged brake mechanism 24 must include a wheel impingement mechanism urged by a spring biasing means for impingement against a wheel surface. As shown herein, the rear wheel 22 is comprises of a wheel 42 rotatably mounted to an axle 44 and supported within a castor frame 46. The upper frame element 47 allows the positioning of a brake plate 50 to be housed between the upper portion of the wheel 42 and the lower surface of the upper frame element 47. A brake plate biasing spring 52 affixed at either end to the upper frame element 47 and the brake plate 50 provides a downward biasing force against the brake plate 50. The actuation cable 38 penetrates the castor frame 46 via a cable guide orifice 56 and terminates rigidly affixes to the brake plate 50 via a guide cable attachment means 58. In this manner, the brake mechanism 24 has a brake urging force applied to the wheels 42 as a static condition; only upon application of an upward releasing force upon the actuation cable 38 will the brake urging force be released.

FIG. 5 shows in greater detail the actuation lever 36 pivotally affixed in relation to the handle 18 such that upward engagement of the lever 36 toward the handle 18 results in an upward engagement for transmitted through the actuation cable 38. The cable guide means 40, herein shown as a guide pulley 40a, allows positioning and guiding of the cable 38 without interference with the nesting access area 34. Additionally, a rotatably mounted guide roller 60 can be provided rotatably supported on the actuation lever 36 can be provided.

2. Operation of the Preferred Embodiment

In accordance with a preferred embodiment of the present invention, as shown in FIG. 6, the a user provides an upward urging force on the actuation lever 36 the spring urged brake mechanism 24 is released and the cart 10 is used in an otherwise conventional manner. It is felt that the user can easily pinch the actuation lever 36 to the handle 18 easily and convenience within the palms of the users hands. Thereafter, upon releasing of the handle 18 the actuation lever 36 is released, pulled downward by the spring urging forces transmitted through the cable 38, and the brake mechanism 24 engages to prevent the cart 10 from traveling.

Because such a self actuated locking mechanism will interfere with retrieval of the carts in a nested fashion, upon nesting of the carts 10 by insertion of the basket 12 of one cart 10 into the basket 12 of another cart by insertion through the nesting access area 34, the upper peripheral rim 16 of the inserted cart will impinge upward against the actuation lever 36 and thereby result in release of the brake urging force. Optionally, the rotatably mounted guide roller 60 will allow the actuation lever to easily roll over the upper peripheral rim of the nested cart.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be limited only by the following claims.

What is claimed is:

1. In a shopping cart having a basket having a front opposite a rear and forming an upper opening circumscribed by an upper peripheral rim, a handle supported at the rear, and said cart rolled and supported on a pair of laterally rotatable, front castor wheels opposite a pair of non-pivoting rear wheels, wherein the improvement comprises:
a spring urged brake mechanism selectively impinge against the rear wheels in order to provide a braking force.

2. The improvement of claim 1, wherein said shopping cart further has along the rear periphery of the basket is a basket rear frame having a pair of basket side frames and forming an unobstructed nesting access area, and wherein said spring urged brake mechanism does not traverse said unobstructed nesting access area.

3. The improvement of claim 2, wherein said spring urged brake mechanism comprises:
an actuation lever mounted in an articulated manner near or to the handle and in mechanical communication with the spring urged brake mechanism by an actuation cable; and
actuation guide means for allowing the mechanical communication of a brake release force from a location remove from the spring urged brake mechanism in a manner that avoids obstruction of or access to the nesting access area.

4. The improvement of claim 2, wherein said spring urged brake mechanism includes a wheel impingement mechanism urged by a spring biasing means for impingement against a wheel surface.
